(19) United States
(12) Patent Application Publication
(10) Pub. No.: US 2026/0255424 A1
(43) Pub. Date: Aug. 27, 2026

(54) RECONFIGURATION PROCEDURES FOR RADIO ACCESS TECHNOLOGIES

(71) Applicant: T-Mobile USA, Inc., Bellevue, WA (US)

(72) Inventor: Roopesh Kumar Polaganga, Bothell, WA (US)

(21) Appl. No.: 19/064,598

(22) Filed: Feb. 26, 2025

(51) Int. Cl. H04W 76/16; H04W 8/22; H04W 24/08; H04W 84/06

(52) U.S. Cl. CPC H04W 76/16; H04W 8/22; H04W 24/08; H04W 84/06

(57) ABSTRACT

Systems, methods, and devices that relate to reconfiguration procedures enabled in part based on priorities of transmissions are disclosed. In one example aspect, a device is caused to perform transmissions with a base station using a second radio access technology that is different from a first radio access technology, receive a signaling from the base station enabling a reconfiguration procedure to use the first radio access technology in part based on a priority of the one or more transmissions, and perform one or more subsequent transmissions using the first radio access technology.

### BACKGROUND

Narrowband Internet of Things (NB-IoT) is a low-power wide-area network (LPWAN) technology developed by the 3rd Generation Partnership Project (3GPP) to address the specific needs of the Internet of Things (IoT). NB-IoT is designed to provide reliable and efficient communication for devices that require low-data rates, long battery life, and extensive coverage. It operates on minimal bandwidth (e.g., less than 200 KHz) and can be deployed in different modes, providing an effective solution for connecting a large number of IoT devices.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a diagram that illustrates configurations for NB-IoT technologies.

FIG. 4 is a diagram that illustrates standalone ranges for NB-IoT technologies.

FIG. 5 is a flow diagram that illustrates a method of the present technology.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

As the number of connected devices continues to grow, wireless communication networks can become congested, leading to inefficiencies and failures. Critical applications that require higher data rates or more immediate connectivity can experience degraded performance. Despite the availability of NB-IoT—a Long-Term Evolution (LTE)-based technology designed for low-bandwidth applications like small messages—current user equipment (UE) still relies heavily on existing radio access technologies (e.g., LTE or New Radio (NR)) for many types of communications. This can lead to resources being unnecessarily consumed by non-urgent, low-data transmissions, such as SMS. Leveraging NB-IoT for low-data messaging can relieve network congestion, improve network performance, and extend battery life for UEs. In particular, enabling UEs to dynamically switch from other radio access technologies (RATs) to NB-IoT for non-urgent, small-data transmissions can free up network resources for more critical, high-data applications. This approach can improve not only the utilization of networks but also energy efficiency and overall system performance in direct-to-device communication.

This patent document discloses techniques that can be implemented to optimize the utilization of networks by dynamically offloading low-data transmissions to NB-IoT. For example, the disclosed techniques can be configured as both a network-based and a UE-based implementation. In a network-based implementation, a node can receive capability information from UEs indicating that the UEs support transmissions using both LTE and NB-IoT networks. The node can perform transmissions with the UE using the LTE network and can monitor the transmissions for certain conditions. For example, in part based on the priority of one or more transmissions, the node can enable or initiate a reconfiguration procedure to reconfigure the user device to use the NB-IoT network. The node can then perform subsequent transmissions with the UE using the NB-IoT network. In a UE-based implementation, a UE that supports transmissions using both LTE and NB-IoT networks can perform one or more transmissions with a base station using an LTE network. The UE can receive a signaling from the node enabling a reconfiguration procedure to use the NB-IoT network. In some implementations, this can be based in part on a priority of the transmissions. The UE can then perform subsequent transmissions with the base station using the NB-IoT network. This offloading process can relieve LTE network congestion and improve overall system performance. It is noted that the disclosed techniques are also applicable to other RATs, such as 5G NR and 6G access technology.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

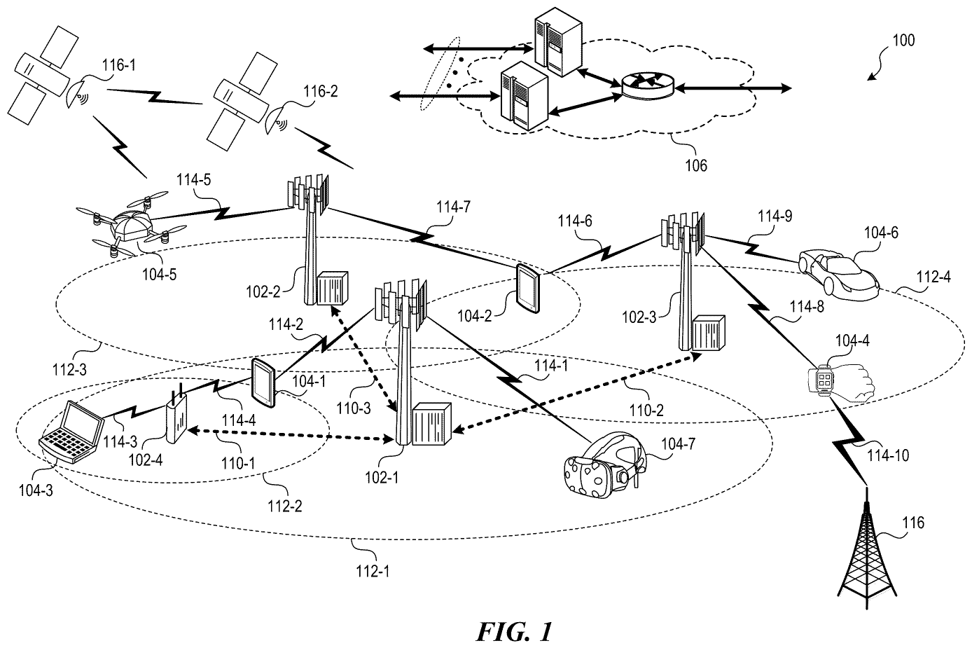

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide-area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G New Radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh Quality of Service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

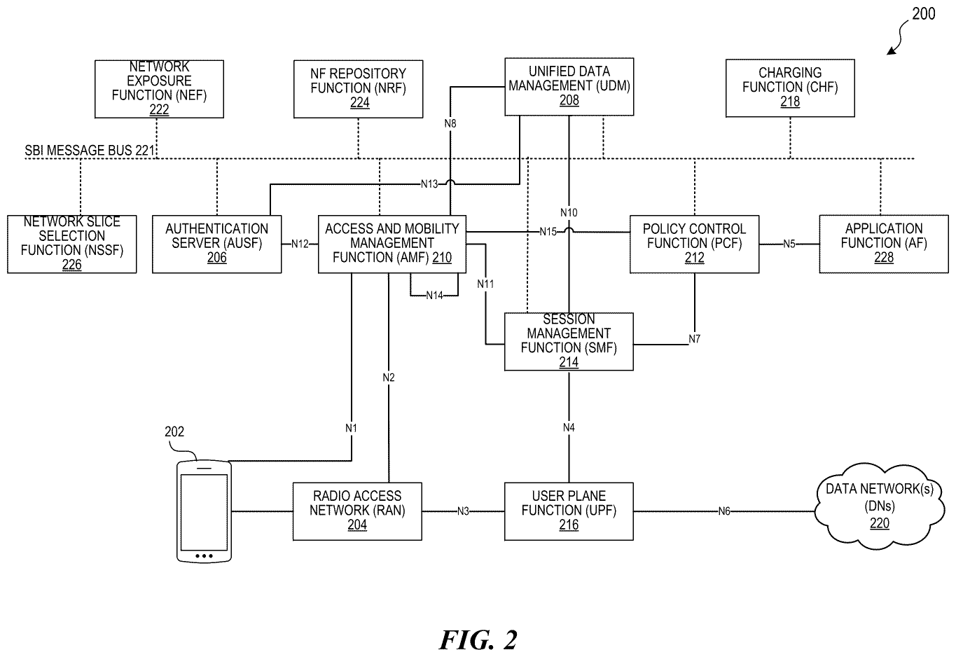

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Reconfiguration Procedures for Radio Access Technologies

Despite the availability of NB-IoT, current UEs still rely on RAT such as LTE for many types of communications. This can lead to network resources being unnecessarily consumed by non-urgent, low-data transmissions, such as SMS. Leveraging NB-IoT for low-data messaging can relieve network congestion, improve network performance, and extend battery life for UEs. In particular, enabling UEs to dynamically switch from other RAT(s) to NB-IoT for non-urgent, small-data transmissions can free up resources for more critical, high-data applications. This approach can improve not only the utilization of networks but also energy efficiency and overall system performance in direct-to-device communication.

This patent document discloses techniques that can be implemented by a node to optimize the utilization of networks by dynamically offloading low-data transmissions to NB-IoT. For example, the disclosed techniques involve broadcasting information by a node in an access network. The node can receive capability information from a user device indicating support for transmissions using an NB-IoT radio access technology in a channel bandwidth limited to 200 kHz. The node can establish a connection with the user device using a different radio access technology. For example, the different radio access technology can be an LTE access technology or a New Radio (NR) access technology. The node can perform one or more transmissions with the user device using the different radio access technology. In some implementations, the node can enable a reconfiguration procedure to reconfigure the user device to use the NB-IoT radio access technology. The node can enable the reconfiguration procedure in part based on a priority of the one or more transmissions. The node can then perform a subsequent transmission with the user device using the NB-IoT radio access technology.

In some implementations, techniques disclosed herein can be performed by a terrestrial node. For example, terrestrial nodes include base stations (e.g., base stations 102), routers, switches, and other networking hardware that are strategically placed to ensure coverage and connectivity. Terrestrial nodes can play a crucial role in the overall performance and reliability of telecommunication networks, as they can handle the routing of data packets, manage network traffic, and provide interfaces for various communication devices.

In some implementations, techniques disclosed herein can be performed by a non-terrestrial node. Non-terrestrial nodes, such as satellites, can be responsible for disseminating essential network information to UEs within their coverage area. This broadcast information can include system parameters, configuration settings, and control messages that are vital for the proper functioning of the network. By broadcasting this information, non-terrestrial nodes ensure that UEs can seamlessly connect to the network, access necessary services, and maintain synchronization with the network's operational protocols. This process is particularly important in scenarios where terrestrial infrastructure is limited or unavailable, as it enables continuous and uninterrupted communication for UEs in remote or underserved areas. The efficient broadcast of information by non-terrestrial nodes enhances the overall performance and reliability of the access network, supporting a wide range of applications and services in diverse environments.

In some implementations, techniques disclosed herein can involve the broadcast of information by the node in the access network. Terrestrial or non-terrestrial nodes can broadcast information to facilitate communication and connectivity with UEs. These nodes can disseminate data packets, control signals, and other information to various UEs within the coverage area. By broadcasting information, nodes in the access network can facilitate seamless handovers, manage network resources, and maintain the quality of service for users. This process can involve the transmission of signals that inform devices about available network services, connection parameters, and other critical updates. Additionally, broadcasting by these nodes can prompt UEs to transmit information, which can be received by the nodes.

In some implementations, the node receives capability information from a user device or a UE. For example, capability information can indicate information or capabilities of the UE, such as support for transmissions using various radio access technologies. In some implementations, the capability information can indicate support for transmissions using a first radio access technology by the user device. For example, the first radio access technology is a Narrowband Internet of Things (NB-IoT) radio access technology in a channel bandwidth limited to 200 kHz. Narrowband Internet of Things (NB-IoT) is a low-power wide-area network (LPWAN) technology developed by the 3rd Generation Partnership Project (3GPP) to address the specific needs of the Internet of Things (IoT). NB-IoT is designed to provide reliable and efficient communication for devices that require low-data rates, long battery life, and extensive coverage. It operates on minimal bandwidth (e.g., less than 200 KHz) and can be deployed in different modes, providing an effective solution for connecting a large number of IoT devices.

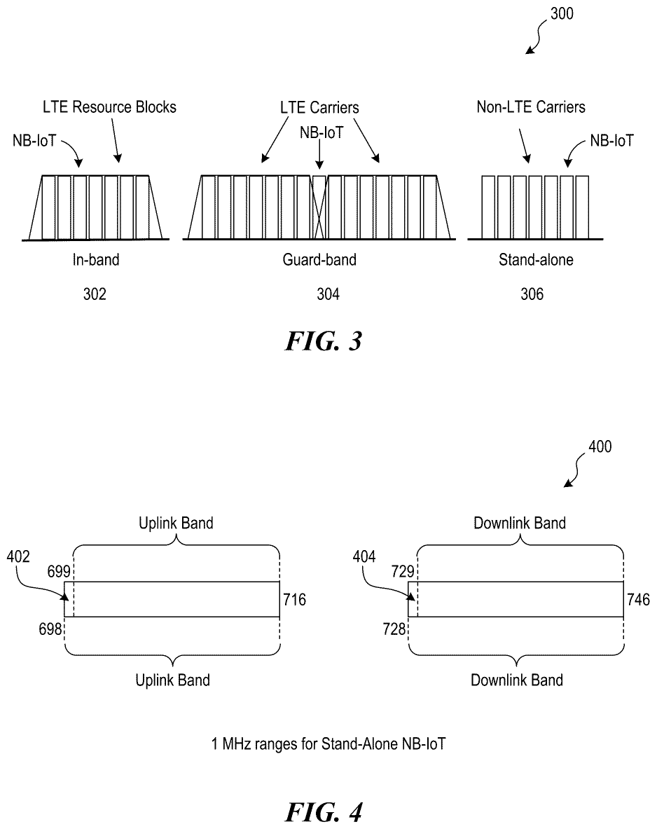

FIG. 3 is a diagram 300 that illustrates configurations for NB-IoT technologies. In some implementations, the user device is configured to support the NB-IoT radio access technology using one or more configurations, including an in-band configuration (e.g., configuration 302), a guard band configuration (e.g., configuration 304), or a standalone configuration (e.g., configuration 306). In the context of in-band operation (e.g., configuration 302), NB-IoT can utilize a 200 kilohertz channel within the LTE carrier, as shown in FIG. 3. This is achieved by blanking one Physical Resource Block (PRB), which is equivalent to 180 kilohertz, in the gNodeB. By not scheduling any LTE data on this particular PRB, it can be dedicated to NB-IoT broadcasting and transactions. This method allows NB-IoT to coexist with LTE within the same carrier, ensuring efficient use of the available spectrum.

Guard band operation (e.g., configuration 304) can sit at the edge of the spectrum. In particular, the guard band operation can be positioned at the edge of one carrier on the right and the edge of a second carrier on the left, as shown in FIG. 3. LTE typically has a wide guard band, which can be spectrally inefficient. While 5G improves this efficiency, the guard band can still include wasted space where broadcasting at higher power is not permitted. This underutilized space can be effectively used for NB-IoT, enabling deployment of IoT services without interfering with the primary LTE or 5G operations.

FIG. 4 is a diagram 400 that illustrates standalone ranges for NB-IoT technologies. Standalone operation (e.g., configuration 306) for NB-IoT can involve using a dedicated frequency band. For example, an operator can own a particular band in certain coverage areas. In some implementations, the particular band includes one extra Megahertz in the UL (e.g., Megahertz 402) and/or the DL (e.g., Megahertz 404), as shown in FIG. 4. This extra Megahertz, which was previously unused, can be used by the carrier as a dedicated NB-IoT band. This also enables migration of LTE carriers to 5G, which can be more efficient and can have less guard band. By dedicating the extra Megahertz to NB-IoT, the operator can ensure that IoT services are supported without compromising the efficiency of 5G services. This approach can not only optimize the use of available spectrum but also prepare the network for the transition to more advanced and efficient technologies.

In some implementations, the node establishes a connection with the user device using a second radio access technology that is different from the first radio access technology. For example, the second radio access technology is at least one of an LTE access technology or an NR access technology. LTE access technology is a standard for wireless broadband communication. It provides high-speed data transmission, low latency, and improved spectral efficiency compared to previous generations of mobile networks. LTE supports a wide range of applications, from high-definition video streaming to real-time gaming, and is the foundation for many modern mobile communication services. NR access technology is a standard for next-generation wireless broadband communication. It provides ultra-high-speed data transmission, significantly lower latency, and enhanced spectral efficiency compared to previous generations of mobile networks. NR supports a wide range of advanced applications, from immersive augmented and virtual reality experiences to massive machine-type communications and critical IoT services. It is the foundation for 5G networks, enabling transformative capabilities and driving innovation across various industries.

In some implementations, the node performs one or more transmissions with the user device using the second radio access technology. This can involve leveraging advanced features such as carrier aggregation, beamforming, and dynamic spectrum sharing to optimize the communication link. By utilizing the second radio access technology (e.g., an LTE access technology or an NR access technology), the node can perform most types of transmissions, regardless of size, priority, or other characteristics of the transmissions. The node can also perform these transmissions with most UEs supporting the second radio access technology.

In some implementations, the node enables a reconfiguration procedure to reconfigure the user device to use the first radio access technology. This process can involve sending control signals and configuration parameters to one or more UEs, instructing them to switch from a current radio access technology to the first radio access technology. During this procedure, the node carefully coordinates the timing and sequence of the control signals to minimize any potential disruption to ongoing communication sessions. The UEs can receive new configuration settings, which can include updated frequency bands, modulation schemes, and other technical parameters required for the first radio access technology. Once the reconfiguration is complete, the UEs can seamlessly transition to the new technology, ensuring that the UEs can continue small-data transmissions without interruption, while the LTE network is relieved of low-priority traffic. This strategic offloading can not only enhance the performance and capacity of the LTE network but also leverage the specialized capabilities of NB-IoT for efficient handling of small-data transmissions.

The reconfiguration can be triggered by various factors. For example, the reconfiguration can be triggered in part based on a priority of the one or more transmissions. The node can determine whether one or more transmissions include one or more high-priority messages by monitoring the one or more transmissions with the UE. High-priority transmissions, such as emergency messages, can require delivery with the highest possible reliability and speed. In such cases, the node can continue to use the second radio access technology, which is optimized for fast and reliable transfer speeds, to handle these critical communications. For instance, during a natural disaster or a public safety incident, emergency alerts and communications from first responders must be transmitted without delay. The node can ensure that these high-priority messages are given precedence over regular traffic, thereby enhancing the effectiveness of emergency response efforts. As such, the node can refrain from reconfiguring UEs when high-priority messages are detected. In some implementations, the node enables the reconfiguration procedure in part based on determining that the one or more transmissions include only one or more low-priority messages.

The reconfiguration can be triggered by various other factors, such as message type detection. If only Signaling Radio Bearers (SRBs) are configured, it can indicate that only small messages, such as SMS, are being transmitted via the Non-Access Stratum (NAS). In some implementations, Dedicated Radio Bearers (DRBs) are not configured for any non-emergency traffic. This configuration can suggest that the data being transmitted does not require high bandwidth or low latency, making it suitable for NB-IoT. By detecting this type of message, the node can switch the UEs to NB-IoT, which is optimized for small-data transmissions and can help offload the LTE network, thereby improving overall network efficiency.

The reconfiguration can be triggered by data buffer monitoring. The node can monitor one or more data buffers temporarily storing the one or more transmissions. For example, the node can continuously monitor the data buffers in both the UL and DL. The node can enable the reconfiguration procedure in part based on determining that a buffer size of the one or more data buffers is below a size threshold. For example, if the buffer size is below an operator-defined threshold, it can indicate minimal traffic. Additionally, if no data requires high priority, the node can offload this traffic to NB-IoT. This approach can ensure that low-priority, small-data transmissions do not occupy valuable resources on the LTE network.

In some implementations, the reconfiguration is triggered by Quality of Service (QoS). If messaging-specific QoS Class Identifiers (QCI) are configured, the network can prioritize the redirection of small-data traffic to NB-IoT. QCIs can be used to define the priority and handling of different types of traffic. When the network identifies that the traffic falls under a QCI category suitable for NB-IoT, it can instruct the UE to switch to the NB-IoT cell within the same frequency band. In some implementations, the reconfiguration process can be triggers by network load balancing, coverage optimization, or the need to support specific services that are better suited to the first radio access technology. Reconfiguration can also be triggered by network conditions, such as congestion or interference, where switching to the first radio access technology can help alleviate these issues and maintain service quality.

In some implementations, the node performs a subsequent transmission with the user device using the first radio access technology. For example, the node can perform a subsequent transmission after the reconfiguration procedure using the NB-IoT radio access technology. In some implementations, the node can perform a predetermined number of subsequent transmissions using the NB-IoT radio access technology before enabling a subsequent reconfiguration procedure to reconfigure the UEs to return to using the second radio access technology. In some implementations, the node can perform one or more subsequent transmissions using the NB-IoT radio access technology for a predetermined time period following the reconfiguration procedure. In some implementations, the node can perform one or more subsequent transmissions using the NB-IoT radio access technology until a subsequent trigger causes the node to enable another reconfiguration procedure to reconfigure the UEs to return to using the second radio access technology.

For example, the node determines, after performing the subsequent transmission with the user device using the first radio access technology, that an attempted transmission is a high-priority message. The node can then enable a subsequent reconfiguration procedure to use the second radio access technology. This subsequent reconfiguration procedure can be triggered at least in part based on determining that the attempted transmission is the high-priority message. In some implementations, the node performs the attempted transmission using the second radio access technology. For example, the node can perform the attempted transmission after the subsequent reconfiguration procedure using the LTE or NR radio access technology. In some implementations, the node can perform a predetermined number of transmissions using the LTE or NR radio access technology before enabling another reconfiguration procedure to reconfigure the UEs to return to using the NB-IoT radio access technology. In some implementations, the node can perform one or more subsequent transmissions using the LTE or NR radio access technology until another trigger causes the node to enable another reconfiguration procedure to reconfigure the UEs to return to using the NB-IoT radio access technology.

This patent document further discloses methods that can be implemented by a UE to dynamically offload low-data transmissions to NB-IoT. The UE can support transmissions using NB-IoT radio access technology and LTE or NR access technology. For example, the disclosed techniques involve performing one or more transmissions with a base station using the LTE or NR access technology. The disclosed techniques can involve receiving a signaling from the base station enabling a reconfiguration procedure to use the NB-IoT radio access technology in part based on a priority of the one or more transmissions. The disclosed techniques can then involve performing subsequent transmissions using the first radio access technology.

In some implementations, a UE transmits, to a node or a base station, capability information indicating support by the UE for transmissions using the first radio access technology. For example, the UE supports transmissions using a first radio access technology and a second radio access technology that is different from the first radio access technology. For example, the first radio access technology is a Narrowband Internet of Things (NB-IoT) radio access technology in a channel bandwidth limited to 200 kHz. The UE can be configured to support the first radio access technology using one or more guard bands or a standalone frequency band, as previously discussed. In some implementations, the second radio access technology is at least one of an LTE technology or an NR technology. In some implementations, the UE performs one or more transmissions with a base station using the second radio access technology (e.g., an LTE or NR access technology).

The UE can receive a signaling from the node or base station enabling a reconfiguration procedure. In some implementations, the reconfiguration procedure can cause the UE to use the first radio access technology. In some implementations, enabling the reconfiguration procedure to use the first radio access technology involves enabling the reconfiguration procedure using the one or more guard bands or the standalone frequency band. The signaling can include control signals and configuration parameters, instructing the UE to switch from the LTE or NR access technology to the NB-IoT access technology. The UE can receive new configuration settings, which can include updated frequency bands, modulation schemes, and other technical parameters required for the first radio access technology. Once the reconfiguration is complete, the UEs can seamlessly transition to the NB-IoT technology.

The reconfiguration can be triggered by various factors. For example, the reconfiguration can be triggered in part based on a priority of the one or more transmissions. The node can determine whether one or more transmissions include one or more high-priority messages by monitoring the one or more transmissions with the UE. In some implementations, the UE receives the signaling enabling the reconfiguration procedure in part based on the node determining that the one or more transmissions include only one or more low-priority messages.

In some implementations, the UE performs a subsequent transmission with the user device using the first radio access technology. For example, the UE can perform a subsequent transmission after the reconfiguration procedure using the NB-IoT radio access technology. In some implementations, the UE can perform a predetermined number of subsequent transmissions using the NB-IoT radio access technology. In some implementations, the UE can perform one or more subsequent transmissions using the NB-IoT radio access technology until a subsequent signaling causes the UE to reconfigure in order to return to using the second radio access technology. In some implementations, the UE can perform one or more subsequent transmissions using the NB-IoT radio access technology for a predetermined time period following the reconfiguration procedure.

In some implementations, the UE receives, after the one or more subsequent transmissions, a second signaling from the node or base station enabling a secondary reconfiguration procedure. The secondary reconfiguration procedure can cause the UE to use the second radio access technology. In some implementations, the second signaling can be generated in response to an attempted transmission being a high-priority message. The UE can then perform the attempted transmission using the second radio access technology. For example, the UE can perform the attempted transmission after the subsequent reconfiguration procedure using the LTE or NR radio access technology. In some implementations, the UE can perform a predetermined number of transmissions using the LTE or NR radio access technology. In some implementations, the UE can perform one or more subsequent transmissions using the LTE or NR radio access technology until another trigger causes the node to enable another reconfiguration procedure to reconfigure the UE to return to using the NB-IoT radio access technology.

In some implementations, the UE receives, after the one or more subsequent transmissions, a second signaling from the node or base station enabling a secondary reconfiguration procedure in response to the node or base station determining that a buffer size of one or more data buffers temporarily storing the one or more subsequent transmissions is below a size threshold. This can indicate that the available space in the one or more data buffers assigned to NB-IoT transmissions is less than the predefined minimum size required for efficient data storage and transmission. In some implementations, the second signaling causes the UE to return to using the second radio access technology. The UE can then perform at least one subsequent transmission using the second radio access technology. This reconfiguration can free up space in buffers specific to NB-IoT transmissions.

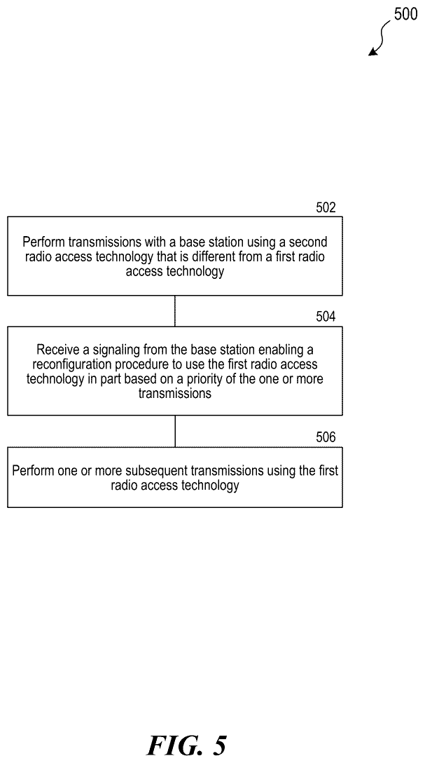

FIG. 5 is a flow diagram that illustrates a method 500 of the present technology. The method 500 includes performing, at operation 502, transmissions with a base station using a second radio access technology that is different from a first radio access technology. For example, the first radio access technology is a Narrowband Internet of Things (NB-IoT) radio access technology and the second radio access technology is at least one of an LTE technology or an NR technology. The method 500 includes receiving, at operation 504, a signaling from the base station enabling a reconfiguration procedure to use the first radio access technology in part based on a priority of the one or more transmissions. For example, the base station can determine whether transmissions include one or more high-priority messages by monitoring the transmissions. In some implementations, the base station determines that the transmissions include only low-priority messages. In some implementations, the signaling can include control signals and configuration parameters, instructing the UE to switch from the LTE or NR access technology to the NB-IoT access technology. The method 500 includes performing, at operation 506, one or more subsequent transmissions using the first radio access technology.

### Computer System

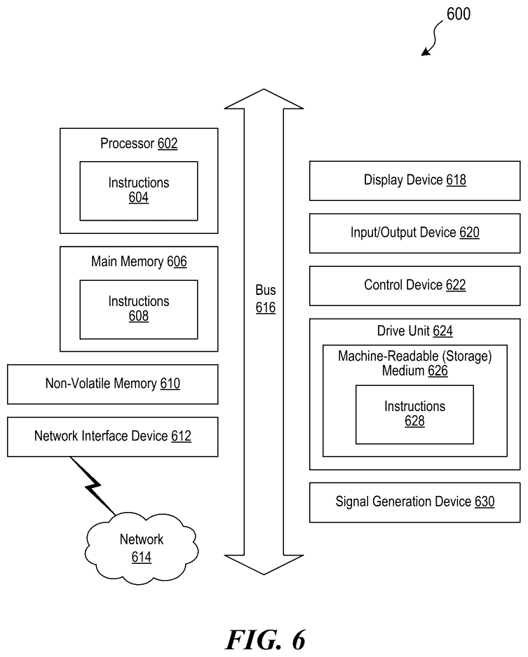

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real time, in near real time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed:

1. A device for wireless communication implemented as a non-terrestrial node in an access network, the device comprising at least one processor that is configured to cause the device to:
broadcast information by the non-terrestrial node in the access network;
receive capability information from a user device indicating support for transmissions using a first radio access technology by the user device,
wherein the first radio access technology is a Narrowband Internet of Things (NB-IoT) radio access technology in a channel bandwidth limited to 200 kHz, and
wherein the user device is configured to support the first radio access technology using one or more guard bands or a standalone frequency band;
establish a connection with the user device using a second radio access technology that is different from the first radio access technology,
wherein the second radio access technology comprises at least one of a Long Term Evolution (LTE) access technology or a New Radio (NR) access technology;
perform one or more transmissions with the user device using the second radio access technology;
enable, in part based on a priority of the one or more transmissions, a reconfiguration procedure to reconfigure the user device to use the first radio access technology; and
perform a subsequent transmission with the user device using the first radio access technology.

2. The device of claim 1, wherein the at least one processor further causes the device to:
determine whether one or more other transmissions include one or more high-priority messages by monitoring the one or more other transmissions with the user device; and
enable the reconfiguration procedure in part based on determining that the one or more other transmissions include only one or more low-priority messages.

3. The device of claim 1, wherein the at least one processor further causes the device to:
monitor one or more data buffers temporarily storing the one or more transmissions; and
enable the reconfiguration procedure in part based on determining that a buffer size of the one or more data buffers is below a size threshold.

4. The device of claim 1, wherein the at least one processor further causes the device to:
determine, after performing the subsequent transmission with the user device using the first radio access technology, that an attempted transmission is a high-priority message;
enable a subsequent reconfiguration procedure to use the second radio access technology in part based on determining that the attempted transmission is the high-priority message; and
perform the attempted transmission using the second radio access technology.

5. A method comprising:
performing, by a user device that supports communications using a first radio access technology and a second radio access technology that is different from the first radio access technology, one or more communications with a base station using the second radio access technology,
wherein the first radio access technology is a Narrowband Internet of Things (NB-IoT) radio access technology in a channel bandwidth limited to 200 kHz, ands
wherein the second radio access technology comprises at least one of a Long Term Evolution (LTE) access technology or a New Radio (NR) access technology;
receiving a signaling from the base station enabling a reconfiguration procedure to use the first radio access technology in part based on a priority of the one or more communications; and
performing one or more subsequent communications using the first radio access technology.

6. The method of claim 5, further comprising transmitting, to the base station, capability information indicating support by the user device for communications using the first radio access technology.

7. The method of claim 5, further comprising:
receiving, after the one or more subsequent communications, a second signaling from the base station enabling a secondary reconfiguration procedure to use the second radio access technology in response to an attempted communication being a high-priority message; and
performing the attempted communication using the second radio access technology.

8. The method of claim 5, further comprising:
receiving, after the one or more subsequent communications, a second signaling from the base station enabling a secondary reconfiguration procedure to use the second radio access technology in response to the base station determining that a buffer size of one or more data buffers temporarily storing the one or more communications is below a size threshold; and
performing at least one subsequent communication using the second radio access technology.

9. The method of claim 5, wherein the reconfiguration procedure causes use of the first radio access technology for a predetermined number of subsequent communications.

10. The method of claim 5, wherein the reconfiguration procedure causes use of the first radio access technology for a predetermined time period following the reconfiguration procedure.

11. The method of claim 5, wherein the user device is configured to support the first radio access technology using one or more guard bands or a standalone frequency band.

12. The method of claim 11, wherein enabling the reconfiguration procedure to use the first radio access technology comprises enabling the reconfiguration procedure using the one or more guard bands or the standalone frequency band.

13. A device for wireless communication comprising at least one processor that is configured to cause the device to:
receive capability information of a user device indicating support for communications using a first radio access technology,
wherein the first radio access technology is a Narrowband Internet of Things (NB-IoT) radio access technology in a channel bandwidth limited to 200 kHz;
establish a connection with the user device using a second radio access technology that is different from the first radio access technology,
wherein the second radio access technology comprises at least one of a Long Term Evolution (LTE) access technology or a New Radio (NR) access technology;
perform one or more communications with the user device using the second radio access technology;
enable, in part based on a priority of the one or more communications, a reconfiguration procedure to reconfigure the user device to use the first radio access technology; and
perform a subsequent communication with the user device using the first radio access technology.

14. The device of claim 13, wherein the at least one processor further causes the device to:
determine whether one or more communication include one or more high-priority messages by monitoring the one or more communications with the user device; and
enable the reconfiguration procedure in part based on determining that the one or more communications include only one or more low-priority messages.

15. The device of claim 13, wherein the at least one processor further causes the device to:
monitor one or more data buffers temporarily storing the one or more communications; and
enable the reconfiguration procedure in part based on determining that a buffer size of the one or more data buffers is below a size threshold.

16. The device of claim 13, wherein the at least one processor further causes the device to:
determine, after performing the subsequent communication with the user device using the first radio access technology, that an attempted communication is a high-priority message;
enable a subsequent reconfiguration procedure to use the second radio access technology in part based on determining that the attempted communication is the high-priority message; and
perform the attempted communication using the second radio access technology.

17. The device of claim 13, wherein the reconfiguration procedure causes use of the first radio access technology for a predetermined number of subsequent communications.

18. The device of claim 13, wherein the reconfiguration procedure causes use of the first radio access technology for a predetermined time period following the reconfiguration procedure.

19. The device of claim 13, wherein the device is configured to support the first radio access technology using one or more guard bands or a standalone frequency band.

20. The device of claim 19, wherein enabling the reconfiguration procedure to reconfigure the user device to use the first radio access technology comprises enabling the reconfiguration procedure using the one or more guard bands or the standalone frequency band.
